(19) United States
(12) Patent Application Publication
(10) Pub. No.: US 2004/0101401 A1
(43) Pub. Date: May 27, 2004

(54) Electromagnetic coupling device for control of hydraulic turbines

(76) Inventor: Timothy David Gerler, Loveland, CO (US)

Correspondence Address: TIMOTHY D. GERLER, 1142 NORTH REDBUD DRIVE, LOVELAND, CO, 80538, US

(21) Appl. No.: 10/302,619

(22) Filed: Nov. 25, 2002

(51) Int. Cl. F03B 3/18

(52) U.S. Cl. 415/150; 415/164

(57) ABSTRACT

A non-contacting electromagnetic coupling device comprised of an electromagnetic coupling rotor (30) and an electromagnetic ring (32) is applied to control and actuate the wicket gates of a hydro turbine. This electromagnetic coupling device extracts mechanical power directly from the rotating hydro turbine/generator and uses the extracted power to close the wicket gates (12) and remove the water loading on the turbine runner (10) during the emergency shutdown event. The electromagnetic coupling device is excited by a direct current power source (36), the output of which is varied to vary the power extracted from the hydro turbine/generator.

### BACKGROUND OF THE INVENTION—FIELD OF INVENTION

This invention relates to control of hydraulic turbines, referred to hereafter more simply as hydro turbines, which are used to turn hydroelectric generators to generate electricity.

### BACKGROUND OF THE INVENTION

In hydroelectric power generation, it important to maintain control of the hydro turbine. This is done by controlling the flow of water to the hydro turbine using wicket gates. If the hydroelectric generator is electrically isolated from the power grid, adjusting the position of the wicket gates controls the speed of the turbine. If the generator is connected to the power grid, the hydro turbine speed is dictated by the power grid frequency so adjusting the position of the wicket gates controls the electrical load generated.

The prior art for controlling a hydro turbine consists of a pressurized oil, fluid power hydraulic system which is utilized to operate hydraulic cylinders, called servomotors in the hydro industry. These servomotors are linear hydraulic actuators which position a control ring. The angular position of this control ring determines the angular position the water flow-controlling wicket gates. The prior art system has been in use for many years and all elements as described are accessible in the public domain.

The most demanding operating scenario for the fluid power hydraulic system is the case in which the electrical circuit breaker to the power grid is opened while the generator is supplying its maximum rated electrical load, removing the load torque in the generator which was balancing the water torque on the turbine. This is referred to as a load rejection and an emergency closure of the wicket gates must be performed rapidly to prevent the hydro turbine/generator from accelerating to speeds which would cause damage. This emergency wicket gate closure is sometimes called an emergency shutdown. The fluid power hydraulic system is sized for this emergency shutdown event. During normal operation however, only a fraction of the capacity of the fluid power hydraulic system is generally required.

The prior art for controlling hydro turbines suffers from a number of disadvantages:

(a) The pressurized oil fluid power hydraulic systems are complicated and costly. In general, the systems contain the following main elements: hydraulic cylinders (servomotors), large fabricated oil pressure tank, high pressure compressed air system, oil reservoir, electric motor driven oil pumps, oil flow unloading valves, oil distributing valves, and oil piping connecting the various components. Because the system is sized for the emergency shutdown event, it can have very large components. Because of the complexity and the fact that each system is customized to its particular hydro turbine, significant engineering and design are required for each system. Additionally, the systems are extremely labor intensive to construct and install.

(b) The prior art systems use petroleum or mineral based hydraulic oil. Even when great care is taken, there is always the potential of releasing the oil into the water which is driving the hydro turbine, usually a river. Containing the oil and protecting the surrounding environment is important to all. Additionally, it is very difficult to create a hydraulic pressure system with clean oil and to maintain the oil cleanliness and quality levels required during years of service. Dirty oil can cause failure of hydraulic components during initial start-up and also decreased reliability of components over time.

(c) Completely-electric actuators are popular in control systems and are preferable to hydraulic actuators where practical. Conventional electrical control actuation for wicket gates has been tried with varying degrees of success, but the large power requirement of the emergency shutdown event has been a major obstacle to implementation of electrical actuators or simple motors. This is especially true since the electrical actuators or motors would most likely need to direct-current driven, which are more expensive per a given power size that alternating-current devices. Alternating-current may not be present in the hydroelectric power plant during the emergency shutdown event. Conventional electrical actuators or motors could, however, be used for normal control operations, since the power requirements are much lower in the normal case.

### BACKGROUND OF THE INVENTION—OBJECTS AND ADVANTAGES

Accordingly, besides the objects and advantages of control systems for hydro turbines described in my patent above, several objects and advantages of the present invention are:

(a) to provide a control system for hydro turbines which is much less complicated, has fewer components and therefore has the potential to cost less to produce and install.

(b) to provide a control system that does not use oil, thereby eliminating the potential for releasing oil into the water and contaminating the environment.

(c) to provide a control actuation system which is completely electric.

### SUMMARY

In accordance with the present invention, the control system for hydro turbines utilizes a unique non-contacting electromagnetic coupling device for the emergency shutdown event. This electromagnetic coupling device extracts mechanical power directly from the rotating hydro turbine/generator and uses the extracted power to close the wicket gates and remove the water loading during the emergency shutdown event. The electromagnetic coupling is excited by direct-current which is varied to vary the power extracted from the hydro turbine/generator.

Normal control actuations of the wicket gates are accomplished using a combination of conventional electric actuators, power extracted from the turbine by the non-contacting electromagnetic coupling, and water loading on the wicket gates.

### DRAWINGS—FIGURES

### BRIEF DESCRIPTION OF THE SEVERAL VIEWS OF THE DRAWING

“The patent or application file contains at least one drawing executed in color. Copies of this patent or patent application publication with color drawing(s) will be provided by the Office upon request and payment of the necessary fee.”

Three full sets of drawings have been supplied with this application. A petition is included with this application explaining why color drawings are necessary. The applicable petition fee has also been included.

In the drawings, closely related figures have the same number, but different alphabetic suffixes.

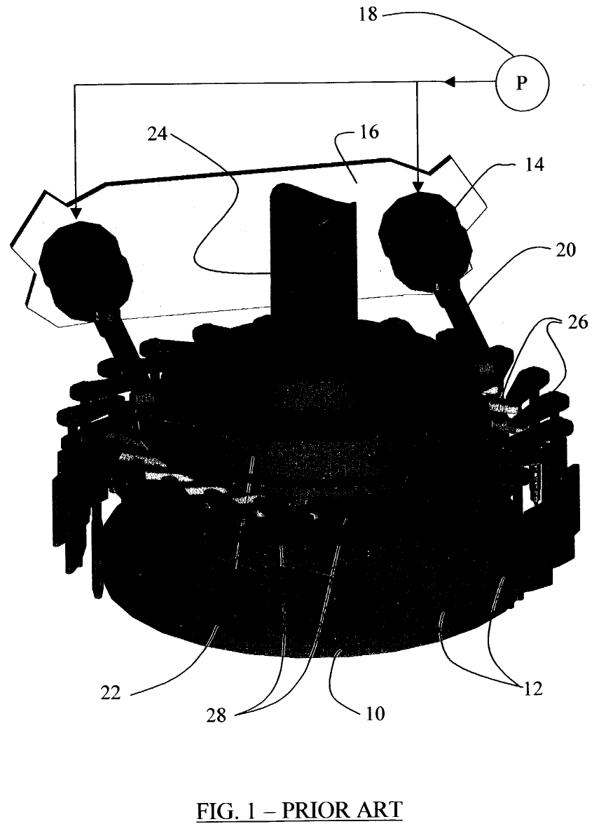

FIG. 1 is a drawing of a hydro turbine showing the prior art for operating wicket gates.

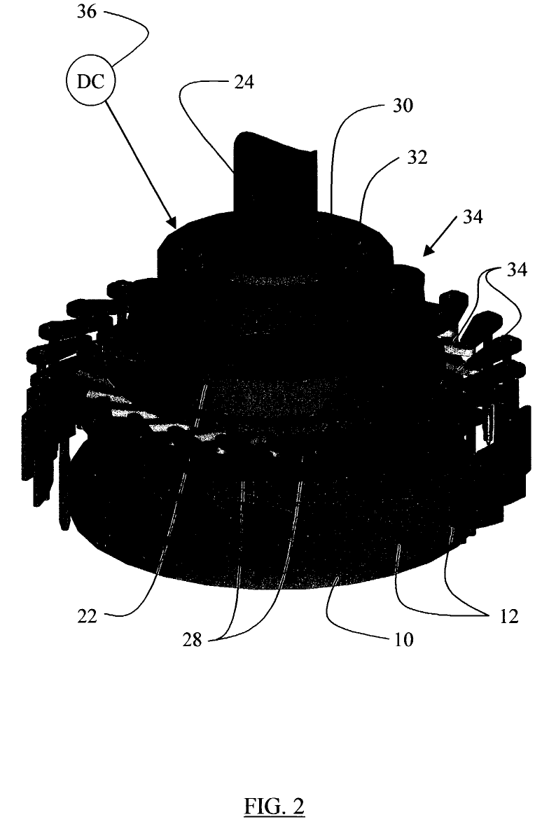

FIG. 2 is a drawing of a hydro turbine with the present invention electromagnetic coupling device for operating the wicket gates.

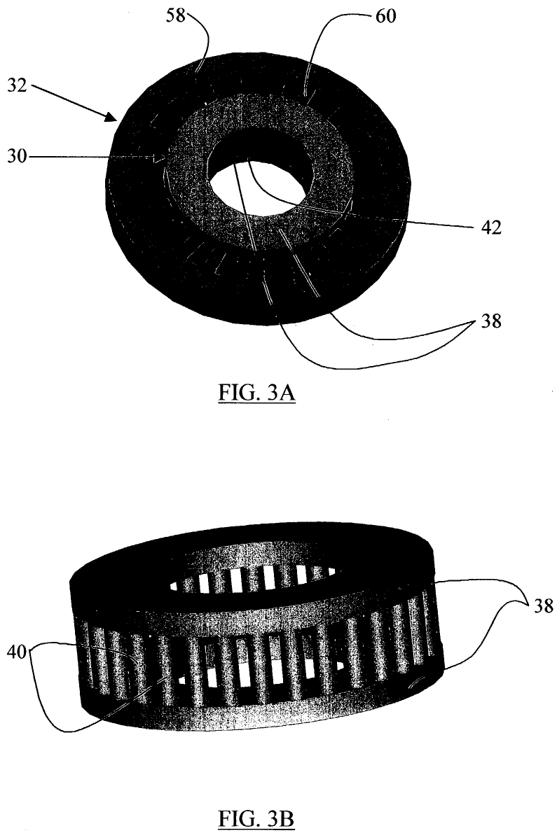

FIGS. 3A and 3B detail the construction of the electromagnetic coupling device.

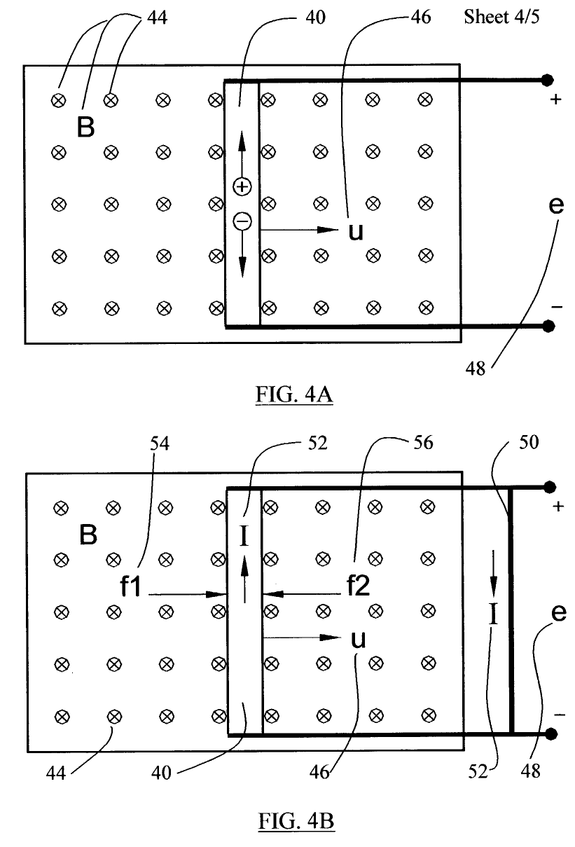

FIGS. 4A and 4B illustrate the physical principle utilized in the electromagnetic transfer of force.

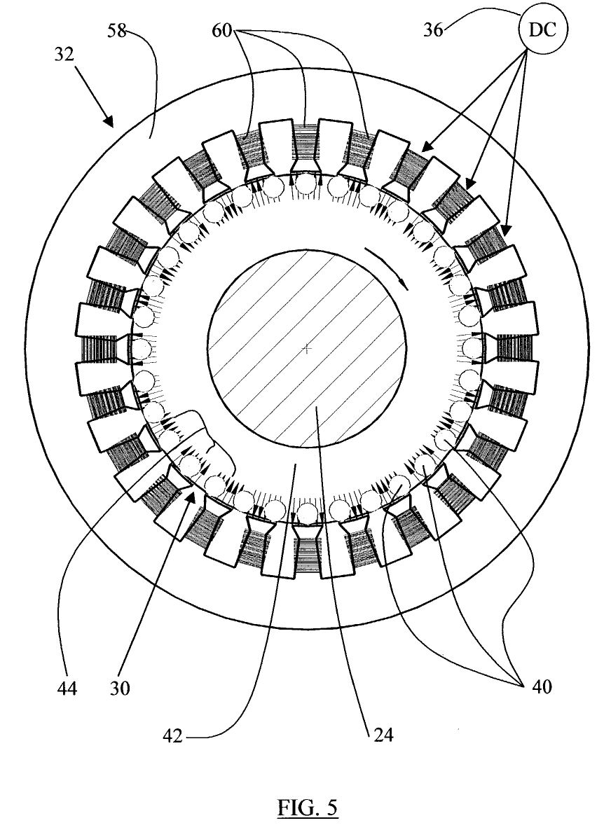

FIG. 5 illustrates how the physical principle is applied to transfer forces, and therefore torque and power, across a non-contacting air gap in order to operate the wicket gates.

### DRAWINGS—Reference Numerals

| | | | |
|---|---|---|---|
| 10 | turbine runner | 12 | wicket gate |
| 14 | hydraulic servomotor | 16 | section of powerhouse wall |
| 18 | hydraulic pressure system | 20 | servomotor link |
| 22 | control ring | 24 | turbine shaft |
| 26 | wicket gate link | 28 | wicket gate lever |
| 30 | electromagnetic coupling rotor | 32 | electromagnetic ring |
| 34 | means for transferring | 36 | direct current power source |
| | rotational energy | | |
| 38 | short-circuiting rotor end cap | 40 | conducting rod |
| 42 | ferromagnetic material of rotor | 44 | magnetic field of density B |
| | | | (vector) |
| 46 | velocity of conducting rod u | 48 | voltage e |
| | (vector) | | |
| 50 | return path for current | 52 | current I (vector) |
| 54 | force on conducting rod f1 | 56 | force on conducting rod f2 |
| | (vector) | | (vector) |
| 58 | ferromagnetic material of | 60 | windings of electromagnetic |
| | electromagnetic ring | | ring |

### DETAILED DESCRIPTION—FIG. 1—PRIOR ART

An embodiment of the prior art is illustrated in FIG. 1. A turbine runner 10 is positioned to receive flowing water. Wicket gates 12 surround the turbine runner 10 and are mounted in such that they may pivot on an axis. Hydraulic servomotors 14 are mounted to a firm foundation depicted as a section of powerhouse wall 16 in FIG. 1. An hydraulic pressure system 18, shown in symbolic form (P), is connected to the hydraulic servomotors 14. A control ring 22 surrounds the turbine shaft 24. The hydraulic servomotors 14 are connected to the control ring 22 by servomotor links 20. The hydraulic servomotors 14 are kinematically linked through the control ring 22. When one hydraulic servomotor 14 extends, the other hydraulic servomotor 14 retracts. Wicket gate levers 28 are attached to the wicket gates 12 at a particular fixed angle. Wicket gate links 26 connect the wicket gate levers 28 to the control ring 22.

### OPERATION—FIG. 1—PRIOR ART

Flowing water turns the turbine runner 10. Flow of water to the turbine runner 10 is controlled by the angular position of the wicket gates 12. Hydraulic oil is delivered to the hydraulic servomotors 14 in a controlled manner by the hydraulic pressure system 18. The hydraulic servomotors 14 extend and retract as dictated by the flow of hydraulic oil from the hydraulic pressure system 18. The extending and retracting of the hydraulic servomotors 14 causes the control ring 22 to rotate about its center. The rotation of the control ring 22 causes movement of the wicket gate links 26 where they attach to the control ring 22. The movement of the wicket gate links 26 causes the wicket gate levers 28 to rotate which, in turn, causes the wicket gates 12 to pivot. In this way, the wicket gates 12 are positioned to control the flow of water to the turbine runner 10.

### DETAILED DESCRIPTION—FIG. 2-3—PREFERRED EMBODIMENT

The embodiment of the present invention is illustrated in FIG. 2. An electromagnetic coupling rotor 30 is rigidly attached to, and rotates with, the turbine shaft 24. An electromagnetic ring 32 surrounds the electromagnetic coupling rotor 30. The electromagnetic ring 32 is supported such that it can rotate independently of the electromagnetic coupling rotor 30. An air gap exists between the inner diameter of the electromagnetic ring 32 and the outer diameter of the electromagnetic coupling rotor 30. There is no physical contact between the electromagnetic ring 32 and the electromagnetic coupling rotor 30. A variable direct current power source 36 is electrically connected to the electromagnetic ring 32.

The electromagnetic ring 32 is connected to the wicket gates 12 by a suitable means for transferring rotational energy 34. For illustrative purposes, and for easy comparison with the prior art, the means for transferring rotational energy 34 is depicted as a gear train connecting the electromagnetic ring 32 to the control ring 22, with the remaining connections to the wicket gates 12 remaining unchanged from the prior art.

FIG. 3A is a more detailed view of the electromagnetic ring 32 and the electromagnetic coupling rotor 30. The electromagnetic coupling rotor 30 has a core, ferromagnetic material of rotor 42, sandwiched between two short-circuiting rotor end caps 38. The electromagnetic ring 32 is configured with ferromagnetic material of electromagnetic ring 58 and windings of electromagnetic ring 60. FIG. 3B shows the electromagnetic coupling rotor 30 without the electromagnetic ring 32, and with the ferromagnetic material of rotor 42 removed. This reveals that evenly spaced conducting rods 40 connect the two short-circuiting rotor end caps 38.

### OPERATION—FIGS. 2-5—PREFERRED EMBODIMENT

In FIG. 2, the wicket gates 12 control the flow of water to the turbine runner 10. When the need to execute an emergency closure of the wicket gates 12 is detected, the direct current power supply 36 energizes the electromagnetic ring 32. When the electromagnetic ring 32 is energized, it applies a braking action to the electromagnetic coupling rotor 30. Since the electromagnetic ring 32 has freedom to rotate, and since it is massively overpowered by the available rotational kinetic energy, the electromagnetic ring 32 is caused to rotate in the same direction as the electromagnetic coupling rotor 30, but at a much slower speed. In this manner, the present invention extracts mechanical energy from the rotating turbine shaft 24.

The rotation of the electromagnetic ring 32 is transformed into rotation of the wicket gates 12 by the suitable means for transferring rotational energy 34. In this manner, the present invention uses mechanical energy extracted from the rotating turbine shaft 24 to perform an emergency closure of the wicket gates 12.

FIGS. 4A and 4B illustrate the operating principle involved. If the conducting rod 40 moves at a velocity u 46 through a magnetic field B 44, a voltage e 48 is induced across the length of the conducting rod 40 (FIG. 4A). If then a return path for current 50 is provided (FIG. 4B), a current I 52 will flow. Now since the current I 52 is also flowing in the conducting rod 40, a force f2 56 develops which resists the motion of the conducting rod 40 through the magnetic field B 44. Additionally, in order to maintain the conducting rod velocity u 46, an external force f1 54 must be applied to the conducting rod 40.

FIG. 5 is a top view of the electromagnetic coupling rotor 30 and the electromagnetic ring 32. The top short-circuiting rotor end cap 38 of the electromagnetic coupling rotor 30 has been removed and a cross-section has been taken of the turbine shaft 24 at that point. Direct current has been applied to 60 by the direct current power source 36. This causes the magnetic field B 44 to develop and jump the air gap. The 42 in the electromagnetic coupling rotor 30 serves to complete the magnetic circuit for the magnetic field B 44, along with the ferromagnetic material of electromagnetic ring 58. Conducting rods 40 in the electromagnetic coupling rotor 30 are forced to pass through the magnetic field B 44.

In this way, the electromagnetic ring 32 applies a torque to the electromagnetic coupling rotor 30 which would tend to stop the electromagnetic coupling rotor 30, and therefore the rotating turbine shaft 24. However, the electromagnetic ring 32 is overpowered and is forced to rotate in the same direction as the electromagnetic coupling rotor 30 and the turbine shaft 24.

### CONCLUSION, RAMIFICATIONS, AND SCOPE OF INVENTION

Thus the reader will see that the electromagnetic coupling device of the invention provides a control system for hydro turbines which is much less complicated (because the hydraulic pressure system is eliminated), does not use oil, and is completely electric in operation.

Note that the direct current applied to the electromagnetic ring, does not “power” the movement of the wicket gates. The direct current only creates magnetic fields. The turbine/generator “power” the conducting rods to move through the magnetic fields, which creates a torque on the electromagnetic ring, causing it to drive the wicket gates. The power extracted from the turbine/generator is far greater than the power required of the direct current power supply to create the magnetic fields.

Although the description above contains many specificities, these should not be construed as limiting the scope of the invention but as merely providing illustrations of some of the presently preferred embodiments of this invention. For example, the means for transferring rotational energy is depicted as a gear train connecting the electromagnetic ring to the conventional control ring. Many other means for transferring rotational energy from the electromagnetic ring to the wicket gates can be used. The means for transferring rotational energy might also incorporate small conventional electric actuators or motors to actuate the wicket gates during normal operation and in maintenance mode. Additionally, the electromagnetic device for extracting rotational energy can also have different configurations.

Thus the scope of the invention should be determined by the appended claims and their legal equivalents, rather than by the examples given.

I claim:

1. An electromagnetic coupling device for control of hydraulic turbines:
1. an electromagnetic device for extracting rotational energy directly from a rotating hydraulic turbine/generator assembly,
2. a means for transferring rotational energy from said electromagnetic device to the wicket gates of said hydraulic turbine,
whereby said electromagnetic coupling device is applied to the control of said hydraulic turbine.
